(19) United States
(12) Patent Application Publication
(10) Pub. No.: US 2007/0109527 A1
(43) Pub. Date: May 17, 2007

(54) System and method for generating position information

(76) Inventor: John Stewart Wenstrand, Menlo Park, CA (US)

Correspondence Address: AVAGO TECHNOLOGIES, LTD., P.O. BOX 1920, DENVER, CO, 80201-1920, US

(21) Appl. No.: 11/273,061

(22) Filed: Nov. 14, 2005

(51) Int. Cl. G01C 3/08; G01B 11/14

(52) U.S. Cl. 356/3.1; 356/623

(57) ABSTRACT

A system for generating position information includes a computing device and a position determination system that is configured to determine the position of a passive pointing element. In an embodiment, the position determination system is integrated into the computing device and includes two detectors that determine the linear or angular position of the passive pointing element, from which triangulation is used to identify the two dimensional position of the passive pointing element. Because the triangulation detectors determine the linear or angular position of the passive pointing element without active input from the passive pointing element, the passive pointing element can be unpowered and untethered.

### CROSS-REFERENCE TO RELATED APPLICATIONS

The present application is related to concurrently filed, co-pending, and commonly assigned U.S. patent application Ser. No. 10/655,944, entitled “Method and System for Optically Tracking a Target Using a Triangulation Technique,” filed Sep. 4, 2003, the disclosure of which is hereby incorporated by herein by reference.

### BACKGROUND OF THE INVENTION

Most position tracking systems used with a graphical user interface (GUI) utilize a mouse to generate two-dimensional position information. The mouse is typically tethered to the computer by an electrical cord through which power is provided from the computer to the mouse and position information is provided from the mouse to the computer. A cordless mouse utilizes a rechargeable or replaceable battery as its power source and radio frequency (RF) signals to communicate position information to the computer. While conventional position tracking systems work well, the electrical cord of a corded mouse can restrict a user's freedom of movement and the power source of a cordless mouse requires constant recharging or replacement.

Another position tracking system used within a GUI is a contact-based system. Contact-based position tracking systems utilize physical contact between a display screen and a pen or a finger to track position. While contact-based position tracking systems work well, the size of the display screen limits a user's range of motion and the location of the display screen can be awkward to access.

### SUMMARY OF THE INVENTION

A system for generating position information includes a computing device and a position determination system that is configured to determine the position of a passive pointing element. In an embodiment, the position determination system is integrated into the computing device and includes two triangulation detectors that determine the linear or angular position of the passive pointing element, from which triangulation is used to identify the two dimensional position of the passive pointing element. Because the triangulation detectors determine the linear or angular position of the passive pointing element without active input from the passive pointing element, the passive pointing element can be unpowered and untethered. Additionally, the position of the passive pointing element can be tracked externally from the computing device without physical contact between the passive pointing element and the computing device, which frees up the range of motion for position tracking.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a system for generating position information that includes a computing device and a pointing element.

FIG. 2A depicts the system of FIG. 1 in which the triangle formed between the computing device and pointing element is solved using the side-side-side method.

FIG. 2B depicts an example of a position determination system that utilizes ultrasonic range finders to determine the distance between the ultrasonic range finders and the pointing element without active input from the pointing element.

FIG. 3A depicts the system of FIG. 1 in which the triangle formed between the computing device and pointing element is solved using the angle-side-angle method.

FIG. 3B depicts an example of a position determination system that utilizes scanned light sources and photodetectors to determine the angular position of the pointing element without active input from the pointing element.

FIG. 3C depicts an example of a position determination system that utilizes divergent light sources and image sensors to determine the angular position of the pointing element without active input from the pointing element.

FIG. 4 depicts an embodiment of the computing device of FIG. 1 in which the position determination system includes a dedicated triangulation processor.

FIG. 5 depicts an embodiment of the computing device of FIG. 1 in which triangulation processing is performed by a central processing unit of the computing device.

FIG. 6 is a perspective view of a computing device and a pointing element relative to a detection area.

FIG. 7 depicts an exemplary embodiment of a position determination system that is integrated with a mobile phone.

FIG. 8 depicts an exemplary embodiment of a position determination system that is integrated with a PDA.

FIG. 9 depicts an exemplary embodiment of a position determination system that is integrated with a laptop computer.

FIG. 10 depicts an exemplary embodiment of a position determination system that is integrated into a desktop computer.

FIG. 11 depicts a computing device that includes a position determination system with triangulation detectors on both the right and left sides of the computing device.

FIG. 12 depicts an embodiment of a position determination system in which the position determination system is physically separate from the computing device.

FIG. 13 depicts a process flow diagram of a method for generating position information for use with a user interface.

Throughout the description similar reference numbers may be used to identify similar elements.

### DETAILED DESCRIPTION

A system for generating position information includes a computing device and a position determination system that is configured to determine the position of a passive pointing element. In an embodiment, the position determination system is integrated into the computing device and includes two triangulation detectors that determine the linear or angular position of the passive pointing element, from which triangulation is used to identify the two dimensional position of the passive pointing element. Because the triangulation detectors determine the linear or angular position of the passive pointing element without active input from the passive pointing element, the passive pointing element can be unpowered and untethered.

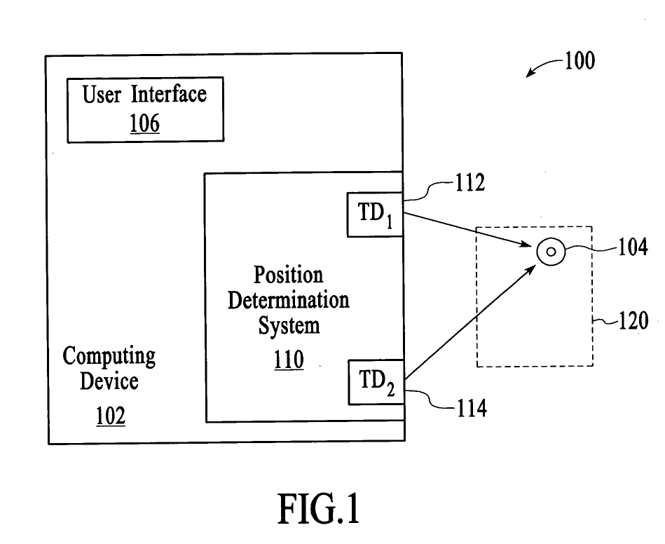

FIG. 1 depicts a system 100 for generating position information that includes a computing device 102 and a pointing element 104. The pointing element is a passive element that does not actively generate any electrical, optical, or acoustical signals that are used for position determination. The computing device includes a user interface 106 and a position determination system 110. The user interface can be any type of user interface that is used with a computing device, including a window-based user interface or any other user interface that tracks the position of the pointing element to navigate within the user interface. Although not shown, the computing device includes a processor and memory that support operation of the user interface. The processor and memory can be any type of processor and memory and may include, for example, a general purpose processor, an application specific processor, ROM, EEPROM, RAM, and flash memory.

The position determination system 10 is embedded into the computing device 102 and includes two triangulation detectors 112, 114. The position determination system generates position information related to the pointing element 104 by triangulation. The distance between the two triangulation detectors is a known value that is pre-established at design. The triangulation detectors each make a position measurement related to the pointing element and the position determination system uses the position measurements along with the known distance between the two triangulation detectors to solve the triangle that is formed between the two triangulation detectors and the pointing element. The position measurements made by each triangulation detector can be, for example, either the linear distances to the pointing element or the angular positions of the pointing element relative to the respective triangulation detectors. If the linear distances between the triangulation detectors and the pointing element are the two position measurements that are made, the triangle can be solved using side-side-side (SSS) triangulation. If the angular positions of the pointing element relative to the two detectors are the two position measurements that are made, the triangle can be solved using angle-side-angle (ASA) triangulation.

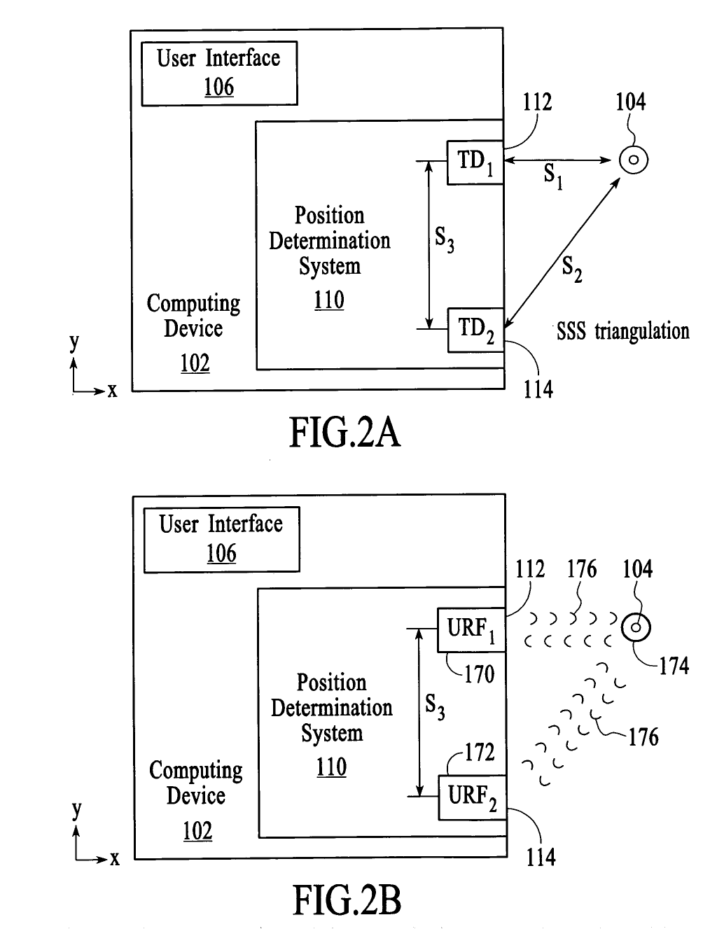

FIG. 2A depicts the case in which the triangle created between the two triangulation detectors 112, 114 and the pointing element 104 is solved using SSS triangulation. Using triangulation detector TD₁, the length of triangle side S₁ is measured and using triangulation detector TD₂, the length of triangle side S₂ is measured. As described above, the length of the triangle side, S₃, between the two detectors is already known. Once the lengths of the triangle's three sides are known, the position of the pointing element is determined by SSS triangulation. In particular, the two dimensional position (e.g., in the x-y plane) of the pointing element is determined.

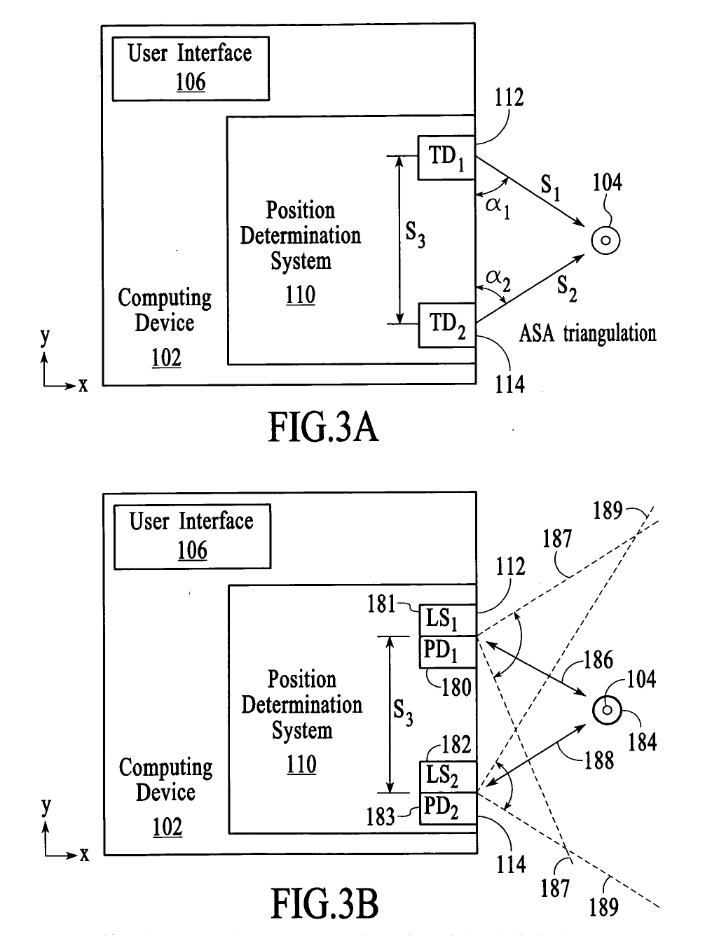

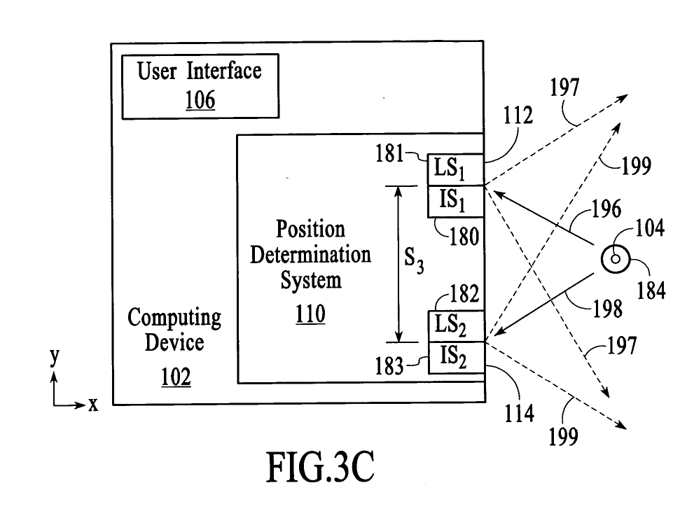

FIG. 3A depicts the case in which the triangle created between the two triangulation detectors 112, 114 and the pointing element 104 is solved using ASA triangulation. Again the length of triangle side S₃ is already known, but the triangulation detectors measure the angular position of the pointing element relative to the respective detectors instead of the lengths of the other two sides of the triangle. In particular, the first angular position, α₁, is measured by triangulation detector TD₁ and the second angular position, α₂, is measured by triangulation detector TD₂. Once the two angles are measured, the two dimensional position of the pointing element is determined by ASA triangulation.

Referring back to FIG. 1, the area within which the position determination system 110 tracks the position of the pointing element 104 is identified by the dashed line box 120 and is referred to as the detection area. The detection area is external to the computing device 102 and is typically established adjacent to the right-hand or left-hand side of the computing device (relative to a user of the device). For example, as depicted in FIG. 1 the detection area is established to the right-hand side of the computing device. The extent of the detection area may be a function of, for example, the limitations of the triangulation detectors 112, 114, an arbitrary user input, the reach limits of a user, or any combination thereof. In one embodiment, the extent of the detection area is a function of the effective range of the triangulation detectors. For example, the effective range of the triangulation detectors is predetermined (e.g., through testing) and the detection area is established as an area that is completely within the effective range of both of the triangulation detectors. In this case, the position determination system is programmed to stop providing position information to the user interface 106 whenever the pointing element is outside the detection area.

As stated above, the triangulation detectors 112, 114 make the linear distance or angular position measurements without active input from the pointing element 104. Various techniques can be used to make the measurements without active input from the pointing element. In one embodiment, the triangulation detectors are ultrasonic range finders that use ultrasonic signals to determine the distance between the triangulation detectors and the pointing element without active input from the pointing element. FIG. 2B depicts an example of a position determination system 110 that utilizes ultrasonic range finders (URF₁ and URF₂) 170, 172 to determine the distance between the ultrasonic range finders and the pointing element without active input from the pointing element. In the example of FIG. 2B, the pointing element is at least partially covered with an acoustic reflector 174 such as an acoustic retroreflector. In operation, the triangulation detectors send out ultrasonic signals 176 that reflect off the pointing element. The distances between the triangulation detectors and the pointing element are a function of the time of flight between signal generation and signal detection. Once the distances between the triangulation detectors and the pointing element are measured, the position of the pointing element (e.g., in the x-y plane) is calculated using SSS triangulation. In an alternative, the position determination system uses only one ultrasonic signal generator with two ultrasonic signal detectors to make the two distance measurements.

In another embodiment, each of the triangulation detectors 112, 114 (FIG. 1) utilizes a scanned light source and a photodetector to measure the angular position of the pointing element 104 without active input from the pointing element. FIG. 3 B depicts an example of a position determination system 110 that utilizes scanned light sources (LS₁ and LS₂) 180, 182 and photodetectors (PD₁ and PD₂) 181, 183 to determine the angular position of the pointing element without active input from the pointing element. In an embodiment, the pointing element is equipped with an optical reflector 184 to enhance reflection of the scanned beam. For example, an optical reflector such as an optical retroreflector can be attached to a pointing element to provide enhanced reflection of the scanned beam. In operation, a beam of light 186, 188 from each triangulation detector is scanned across an angular range (as indicated by dashed lines 187 and 189, respectively) that includes the detection area and the photodetectors are monitored for detection pulses that result from light reflecting off the pointing element. A detection pulse is correlated to the scanning angle to determine the angular position of the pointing element relative to the respective light source.

Alternatively, a known technique for sensing an angle is widely deployed in VOR (VHF Omnidirectional Radiobeacon) aviation navigation systems. The technique utilizes RF energy but can be adapted to operate with optical energy. Once the angular positions (α₁ and α₂, FIG. 3A) of the pointing element relative to the triangulation detectors are measured, the position of the pointing element (e.g., in the x-y plane) is calculated using ASA triangulation.

In another embodiment, each of the triangulation detectors 112, 114 includes a light source and an image sensor. The light source provides divergent light. The image sensor is, for example, an image sensor having a 1-D or 2-D array of sensor elements, and determines angular position without active input from the pointing element 104. FIG. 3C depicts an example of a position determination system 110 that utilizes divergent light sources (LS₁ and LS₂) (190, 192 and image sensors (IS₁ and IS₂) 191, 193 to determine the angular position of the pointing element without active input from the pointing element. In operation, divergent light from each triangulation detector is projected into the detection area throughout the range identified by dashed lines 197 and 199, respectively. A portion of the divergent light 196, 198 is reflected by the pointing element and detected by the corresponding image sensor. The location of the reflected light in the image detected by the image sensor is correlated to an angular position of the pointing element. Similar processing is carried out for both triangulation detectors to determine angles, α₁ and α₂ (FIG. 3A). The position of the pointing element (e.g., in the x-y plane) is then calculated using ASA triangulation. Again, the pointing element can be equipped with a reflector to enhance reflection of the divergent light. For example, a reflector 184 such as a retroreflector can be attached to a pointing element to provide enhanced reflection of the divergent light back to the detectors.

In all of the above-described techniques, no active input is required from the pointing element 104 to make a position measurement. That is, the pointing element is a passive element that does not actively generate any electrical, optical, or acoustical signals that are used for the position measurements. Additionally, the position measurements do not rely on contact between the pointing element and any other surface or device.

The type of pointing element that is used with the position determination system 110 is a function of the type of triangulation detectors 112, 114 that are used and may include, for example, a mouse, a stylus, or a finger. In one embodiment, the pointing element is a stylus that includes a retroreflective band and in another embodiment, the pointing element is a retroreflector that is attached to a user's finger. Other examples of pointing elements include a desktop mouse-type device that includes a retro-reflector. In one embodiment, the pointing element is a cylindrical device in which the returned signal is independent of the rotational position of the pointing device.

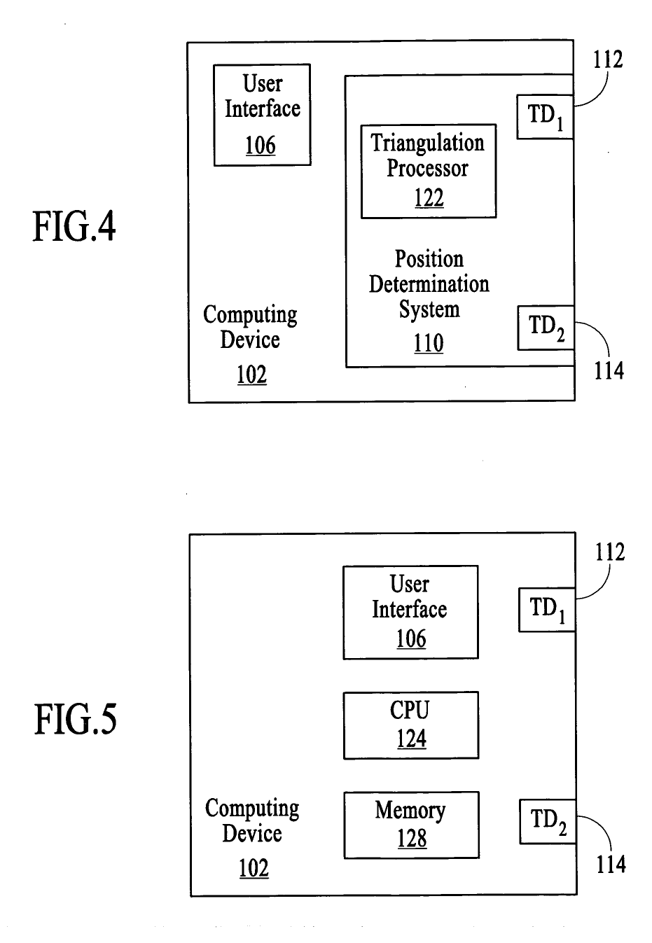

The triangulation processing that is done by the position determination system 110 to determine the position information can be performed by, for example, a dedicated triangulation processor or by a general purpose processor. FIG. 4 depicts an embodiment of the computing device 102 in which the position determination system includes a dedicated triangulation processor 122. In this embodiment, the triangulation processor is an application specific integrated circuit (ASIC) that is configured to output two-dimensional coordinates (e.g., x and y) that identify the position of the pointing element. Although described as an ASIC in this example, the triangulation processor can be any hardware, software, firmware, or combination thereof that can generate the desired position information.

FIG. 5 depicts an embodiment of the computing device 102 in which triangulation processing is performed by a central processing unit (CPU) 124 of the computing device 102. FIG. 5 also depicts a user interface 126 and memory 128 of the computing device. The user interface can be, for example, a display screen, a keypad, or a combination thereof. The user interface, CPU, and memory support the user interface 106 of the computing device as depicted in FIG. 1. In the embodiment of FIG. 5, linear distance or angular position measurements are provided by the triangulation detectors 112, 114 to the CPU for triangulation processing.

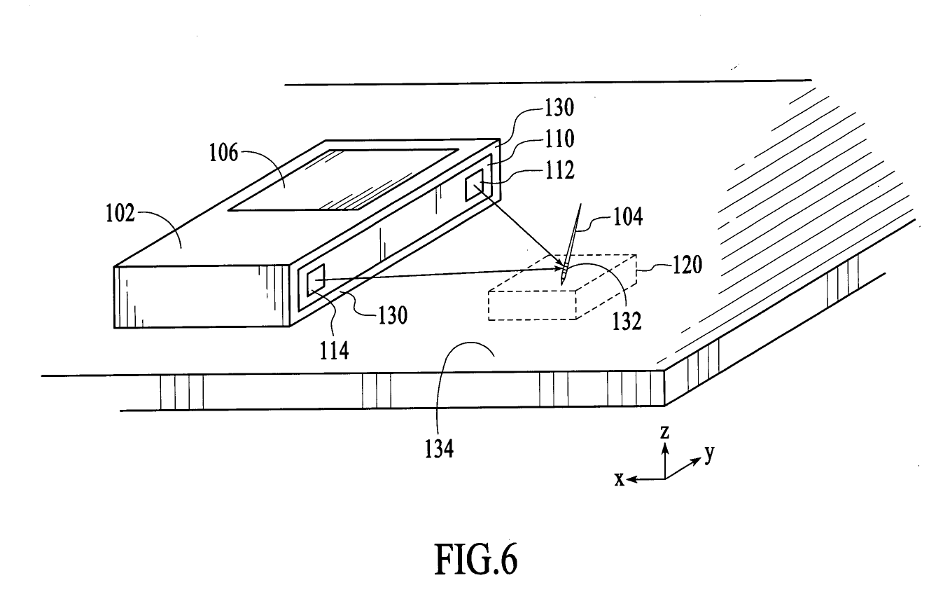

FIG. 6 is a perspective view of the computing device 102 of FIG. 1 relative to the detection area 120 and the pointing element 104. In the embodiment of FIG. 6, the triangulation detectors 112, 114 are embedded into a side surface 130 of the computing device and exposed enough to allow for the position measurements to be made. Additionally, the triangulation detectors are located at opposite ends of the side surface to optimize the accuracy of detection within the detection area. As illustrated in FIG. 6, the detection area is external to the computing device and may include a height dimension (e.g., in the z direction) within which the pointing element is tracked. Although the position of the pointing element is not tracked in the z direction, the height dimension allows more freedom in the range of motion of the pointing element. In the embodiment of FIG. 6, the pointing element is a stylus that includes a reflector 132, such as a retroreflector wrapped around a portion of the stylus.

In an exemplary operation, the computing device 102 is placed on a flat surface 134 such as a desktop and the position determination system is activated. The detection area 120 is established outside the footprint of the computing device as indicated by the dashed line box. The pointing element 104 is placed into the detection area and manipulated by a user to navigate a user interface that is active on the computing device. As the pointing element is moved within the detection area, the triangulation detectors of the position determination system continuously make position measurements (e.g., either linear distance or angular position) from which triangulation processing is used to determine the position of the pointing element. The position information is communicated to the user interface and translated to a position indication on the user interface 126 of the user interface, for example, as the position of a cursor on a display screen.

The resolution of the position determination system 110 is a function of the rate of position calculations and the resolution of the triangulation detectors 112, 114. In an embodiment, triangulation calculations are performed one-hundred times per second. In general, the required minimum resolution of the position detection system is a function of the size of the detection area and the resolution requirements of the particular application.

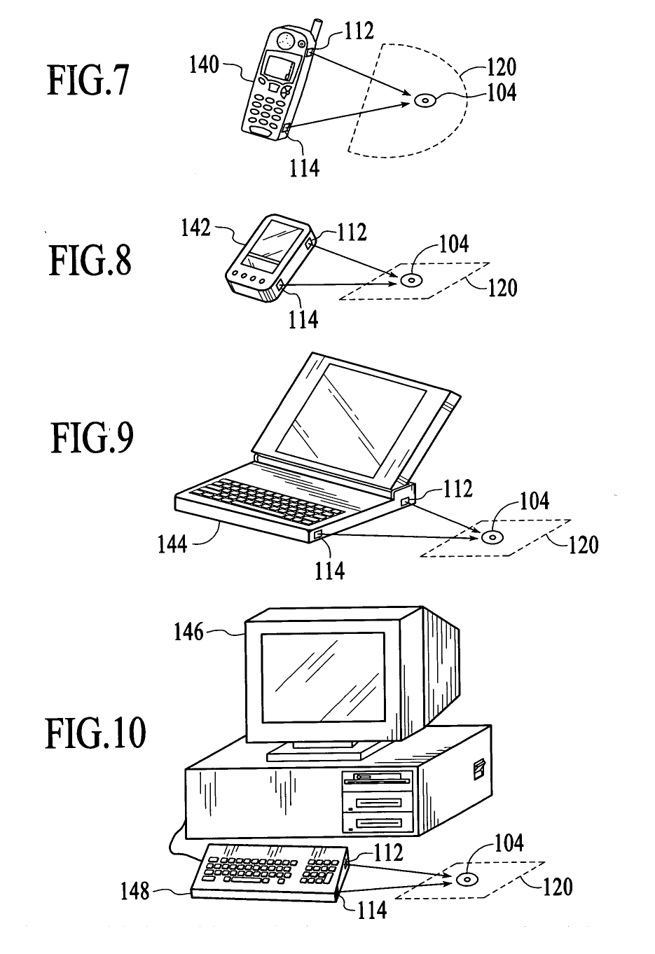

The position determination system 10 described above with reference to FIGS. 1-6 can be integrated with different types of computing devices. Exemplary computing devices with which the position determination system can be used include a mobile phone, a personal digital assistant (PDA), a laptop computer, or a desktop computer. FIG. 7 depicts an exemplary embodiment of a mobile phone 140 that includes a position determination system as described above, of which only the triangulation detectors 112, 114 are shown. In this embodiment, the triangulation detectors are embedded into a side of the mobile phone such that the detection area 120 is established adjacent to the mobile phone. In an exemplary operation, the mobile phone is placed on a flat surface (not shown) with the detection area established adjacent to and outside the footprint of the mobile phone. The pointing element 104 is then moved within the detection area to navigate within the user interface of the mobile phone. For example, a finger can be moved within the detection area to navigate within the mobile phone's user interface. As illustrated in FIG. 7, the detection area can have a shape other than square or rectangular and the particular shape of the detection area is not critical to the invention.

FIG. 8 depicts an exemplary embodiment of a PDA 142 that includes a position determination system 110 as described above, of which only the triangulation detectors 112, 114 are shown. In the embodiment of FIG. 8, the triangulation detectors are embedded into a side of the PDA similar to that of the mobile phone. In an exemplary operation, the PDA is placed on a flat surface (not shown) with the detection area 120 established adjacent to and outside the footprint of the PDA. The pointing element 104 is then moved within the detection area to navigate within the user interface of the PDA.

Although the mobile phone 140 and PDA 142 are described as being placed on a flat surface during position tracking operations, position tracking is not limited to instances when the computing device is located on a flat surface and the detection area 120 is not limited to being adjacent to a flat surface. For example, the position of the pointing element 104 can be tracked within the detection area when the computing device is being held by a user or positioned in a stand or charging device such that the detection area is entirely in free space.

FIG. 9 depicts an exemplary embodiment of a laptop computer 144 that includes a position determination system 110 as described above, of which only the triangulation detectors 112, 114 are shown. In this example, the triangulation detectors are positioned in a side surface of the main laptop structure so that the detection area 120 is in a convenient location for a user. As illustrated in FIG. 9, the detection area is located adjacent to and outside the footprint of the laptop at a distance that is convenient for the user of the laptop.

FIG. 10 depicts an exemplary embodiment of a desktop computer 146 that includes a position determination system 110 as described above, of which only the triangulation detectors 112, 114 are shown. In this example, the triangulation detectors are embedded into a side surface of the desktop computer's keyboard 148 and the detection area 120 is established adjacent to and outside the footprint of the keyboard. Again, the detection area is established in an area that is convenient for the user of the desktop computer.

Referring back to FIG. 1, the computing device 102 can be equipped with a position determination system 110 that allows a characteristic of the detection area 120 to be manipulated. In one embodiment, the size and/or shape of the detection area can be adjusted. For example, the detection area can be made larger or smaller depending on various operating and environmental conditions. Additionally, operating parameters of the triangulation detectors can be adjusted in response to environmental conditions. For example, the optical or acoustical power of the triangulation devices can be increased to account for increased optical or acoustical interference.

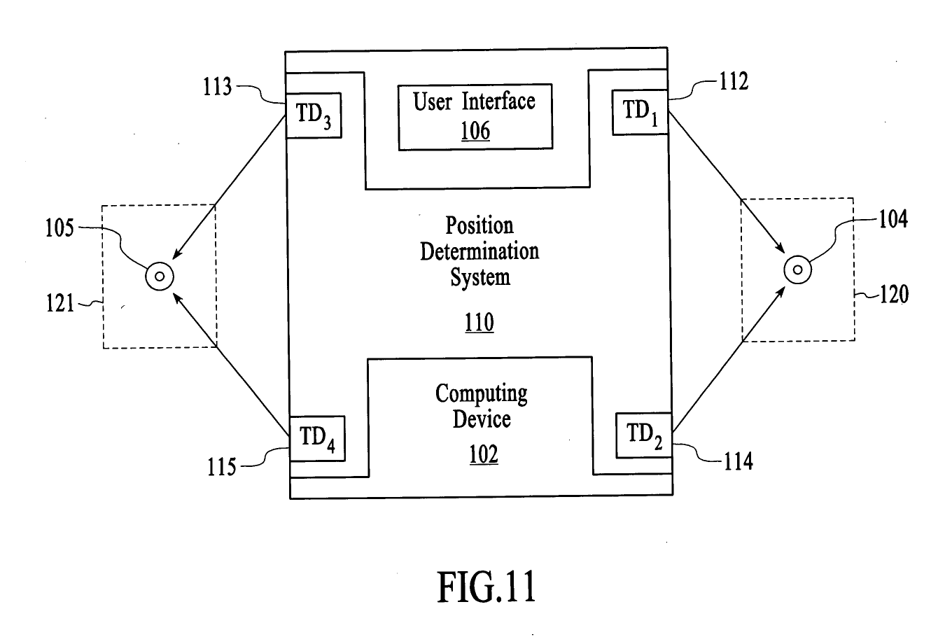

In another embodiment as depicted in FIG. 11, a detection area 120, 121 is established on either the right or left side of the computing device 102 (relative to a user of the computing device) to accommodate right- or left-handed users. To support both right and left side detection areas, two triangulation detectors 112, 114 and 113, 115 are embedded into each side of the computing device. The triangulation detectors can be activated on either the right or left side for right or left hand position tracking or on both sides simultaneously for simultaneous right and left hand tracking of two pointing elements 104, 105.

Although the position determination system 110 is described as having only two triangulation detectors 112, 114, the position determination system may include more than two triangulation detectors. The benefits of multiple triangulation detectors include the possibility of combining readings from different detectors to generate more accurate position information, the ability to drop the readings from a detector that is not positioned favorably with reference to the pointing device, and the ability of the system to operate when a detector is not able to produce data because of a malfunction or occlusion.

In an alternative embodiment, the position determination system does not rely on triangulation to determine the position of a passive pointing element. For example, the position determination system includes two co-located detectors that make respective position measurements. One detector is configured to determine the linear distance between the detector and the pointing element and the other detector is configured to determine the angular position of the pointing element. With the linear distance and the angular position of the pointing element known relative to the co-located detectors, the position of the pointing element (e.g., in the x-y plane) can be determined. Exemplary detectors that can be co-located to determine the linear and angular position of a passive pointing element are described above with reference to FIGS. 2A-3C.

Although the triangulation detectors 112, 114 are described as being positioned on a side surface of the computing device 102, the triangulation detectors can be positioned in other locations within the computing device as long as the position of the pointing element can be determined.

The function of the triangulation detectors 112, 114 is to measure the position (e.g., either linear distance or angular position) of the pointing element 104 without active input from the pointing element. Although some techniques for measuring the position of the pointing element without active input from the pointing element are described above, other techniques for measuring the position of the pointing element without active input from the pointing element are possible.

The position determination system 110 described above enables position tracking of a pointing element 104 that is passive with respect to position determination. When used to navigate within a user interface, it is desirable for the pointing element to have the ability to emulate certain mouse functions such as “clicking,” “dragging,” or “scrolling.” In an embodiment, the pointing element is configured with a mechanism or mechanisms to generate signals that can be used to emulate certain mouse functions without requiring the pointing element to have power. Examples of mechanisms that can be incorporated into a pointing element are described in the co-pending U.S. patent application Ser. No. [to be added] and entitled “[to be added]”, which is assigned to the assignee of the current application and incorporated by reference herein. Alternatively, the pointing element can include a powered mechanism that is used to generate signals that are used for a function other than position determination.

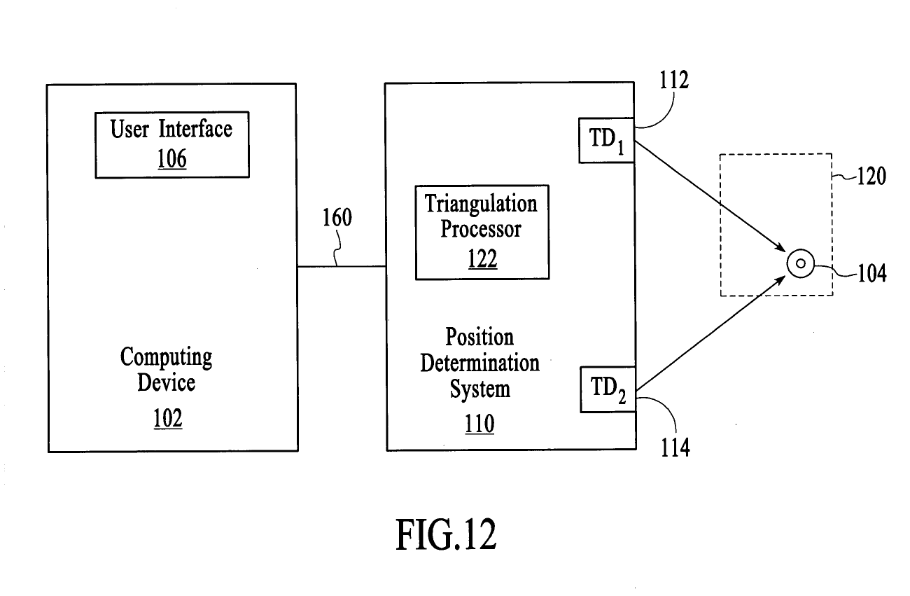

In the embodiments of FIGS. 1-11, the position determination system 110 is embedded into the computing device 102, for example, into a side surface of the computing device. In another embodiment, the position determination system can be physically separate from the computing device. FIG. 12 depicts an embodiment of a position determination system 110 in which the position determination system is physically separate from the computing device 102. The position determination system and computing device are connected by a communications link 160 (e.g., a wired or wireless link) through which position information is communicated from the position determination system to the computing device. In the embodiment of FIG. 12, the position determination system includes triangulation detectors 112, 114 and a triangulation processor 122 for generating position information as described above with reference to FIG. 4. In an alternative embodiment, the triangulation detectors are physically separate from the computing device and the triangulation processing is performed by the computing device. In one configuration, the position determination system is embodied as a base station that is connected to the computing device through a standard connection such as a USB connection.

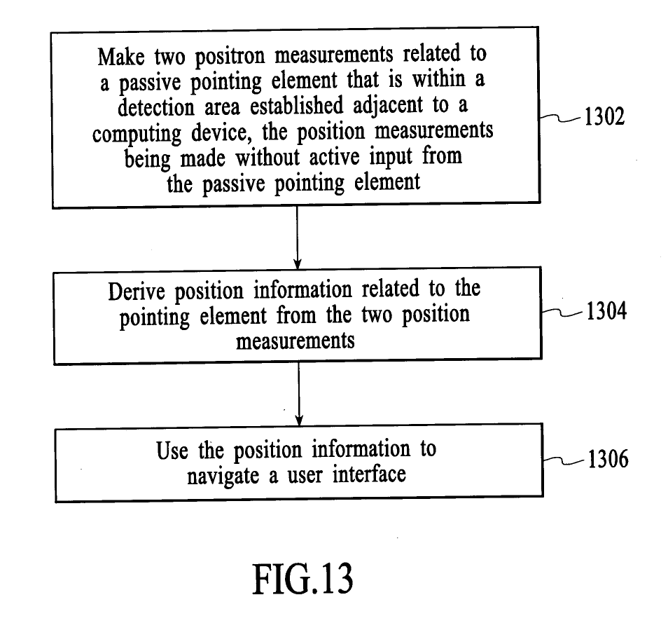

FIG. 13 is a process flow diagram of a method for generating position information for use with a graphical user interface. At block 1302, two position measurements are made related to a passive pointing element that is within a detection area established adjacent to a computing device, the position measurements being made without active input from the passive pointing element. At block 1304, position information related to the pointing element is derived from the two position measurements. At block 1306, the position information is used to navigate a user interface.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for generating position information, the system comprising:
a computing device; and
a position determination system comprising first and second detectors, the position determination system being configured to generate position information related to a passive pointing element.

2. The system of claim 1 wherein the first and second detectors establish a detection area.

3. The system of claim 2 wherein the detection area is adjacent to and outside the footprint of the computing device.

4. The system of claim 2 wherein the extent of the detection area is adjustable.

5. The system of claim 1 wherein the first and second detectors are configured to make first and second position measurements, respectively, related to the pointing element.

6. The system of claim 5 wherein the first and second detectors are configured to make the first and second position measurements within a detection area that is adjacent to and outside the footprint of the computing device.

7. The system of claim 5 wherein the first and second position measurements are the linear distances between the detectors and the passive pointing element.

8. The system of claim 7 wherein the triangulation detectors comprise ultrasonic range finders.

9. The system of claim 5 wherein the first and second position measurements denote the angular positions of the passive pointing element relative to the detectors.

10. The system of claim 9 wherein the detectors comprise a source of an angularly scanned collimated beam of light and a photodetector.

11. The system of claim 9 wherein the detectors comprise a light source and an image sensor.

12. The system of claim 1 wherein the position determination system is integrated into the computing device and wherein the first and second detectors are exposed at a surface of the computing device.

13. The system of claim 1 wherein the position determination system further comprises a triangulation processor configured to identify the position of the passive pointing element by triangulation.

14. The system of claim 1 wherein the position determination system is configured to find one of a side-side-side (SSS) solution to a triangle, an angle-side-angle (ASA) solution to a triangle, or a side-angle solution to identify the position of the passive pointing element, wherein the triangle is created between the detectors and the passive pointing element.

15. The system of claim 1 wherein the passive pointing element is a passive element with respect to position determination.

16. The system of claim 1 wherein the passive pointing element comprises a reflector.

17. A system for generating position information, the system comprising:
a computing device; and
a position determination system integrated into the computing device, the position determination system comprising first and second detectors configured to establish a detection area within which the position of a passive pointing element can be determined.

18. A method for generating position information, the method comprising:
making two position measurements related to a passive pointing element that is within a detection area established adjacent to a computing device, the position measurements being made without active input from the passive pointing element;
deriving position information related to the pointing element from the two position measurements; and
using the position information to navigate a user interface.

19. The method of claim 18 wherein making the two position measurements comprises determining the linear distance between two triangulation detectors and the passive pointing element.

20. The method of claim 18 wherein making the two position measurements comprises determining the angular position of the passive pointing element relative to two triangulation detectors.
